(19) United States
(12) Patent Application Publication
(10) Pub. No.: US 2013/0149583 A1
(43) Pub. Date: Jun. 13, 2013

(54) BATTERY SYSTEM

(71) Applicant: Akio Kurita, Tokyo (JP)

(72) Inventor: Akio Kurita, Tokyo (JP)

(73) Assignee: MITSUBISHI HEAVY INDUSTRIES, LTD., Tokyo (JP)

(21) Appl. No.: 13/818,008

(22) PCT Filed: Sep. 27, 2011
(86) PCT No.: PCT/JP2011/072045

§ 371 Date: Feb. 20, 2013

(30) Foreign Application Priority Data
Nov. 9, 2010 (JP) 2010-251124

(51) Int. Cl. H01M 10/50

(52) U.S. Cl. CPC H01M 10/5067
USPC 429/120

(57) ABSTRACT

A battery system of the invention includes a plurality of electrical cells, a battery accommodation casing, and a cooling fan. A bottom portion of an accommodation portion of the battery accommodation casing is provided with a cooling fluid introduction port that introduces the cooling air, and any one or both of the side portion side of a cover portion of the battery accommodation casing and the upper portion side of a side portion of the accommodation portion are provided with a cooling fluid discharge port (a first cooling fluid discharge port) that discharges air inside the battery accommodation casing. Furthermore, the cover portion facing the accommodation portion is provided with a cooling air guide portion.

### TECHNICAL FIELD

The present invention relates to a battery system that includes a battery pack in which a plurality of electrical cells are arranged inside a battery accommodation casing.

Priority is claimed on Japanese Patent Application No. 2010-251124, filed on Nov. 9, 2010, the content of which is incorporated herein by reference.

### BACKGROUND ART

A battery pack which is mounted on a battery system of an electric vehicle or the like is configured by accommodating a plurality of electrical cells as a battery assembly in a casing such as a battery accommodation casing. Then, inside the battery accommodation casing, the electrode terminals of the plurality of electrical cells arranged with a predetermined gap therebetween are connected to each other by a busbar, and a space used for the circulation of air is formed between the electrical cells (hereinafter, the space formed by the predetermined gap is referred to as a “side space”). Since the respective electrical cells configuring the battery assembly generate heat due to charging and discharging, a cooling device is provided inside the battery accommodation casing or is connected to the battery accommodation casing so as to discharge the heat generated from the electrical cell to the outside of the battery accommodation casing.

As an application example of the cooling device, for example, Patent Document 1 discloses an electrical storage system (corresponding to the “battery system”) in which cooling air is supplied to the side space between adjacent electrical cells from one side and is suctioned from the other side by an air control device such as a fan or a blower so as to discharge the air present in the side space to the outside of a battery accommodation casing. In the electrical storage system, the cooling air which passes through a heat exchanger for a cooler is supplied upward from the lower side of the side space between the electrical cells.

### PRIOR ART DOCUMENT

### Patent Document

[Patent Document 1] Japanese Patent No. 2903913

### SUMMARY OF INVENTION

### Problems to be Solved by the Invention

In general, the positive and negative electrodes of the electrical cell are accommodated inside a battery can with a separator interposed therebetween, and the positive and negative electrodes are respectively connected to the electrode terminal. Then, since a current which is generated by the charging and discharging is supplied to the outside of the electrical cell through the electrode terminal, the electrical cell has a structure in which the amount of generated heat of the electrode terminal is large and the upper space of the electrode terminal is apt to be heated.

However, in the electrical storage system of Patent Document 1, as illustrated in FIGS. 14 and 15, the cooling air which is supplied to the side space between the electrical cells moves upward in the side space from the lower side of the battery accommodation casing, and is directly discharged to the outside of the battery accommodation casing by a discharge port, a fan, or the like provided in the upper portion. That is, in the cooling device with the structure illustrated in Patent Document 1, the cooling air is not sufficiently supplied to the upper side of the electrode terminal of the electrical cell with a large heating amount, and is discharged to the outside of the battery accommodation casing through the side space of the electrical cell which insufficiently undergoes a heat exchange with the electrical cell generating heat. For this reason, the terminal surface of the electrical cell having the electrode terminal cannot be efficiently cooled, which is one factor that leads to degradation in the electrical cell or degradation in the performance of the battery system.

The invention is made in view of the above-described problems, and it is an object of the invention to provide a battery system capable of efficiently cooling each of electrical cells accommodated therein by a cooling fluid.

### Means for Solving the Problem

According to the present invention, there is provided a battery system including: a plurality of electrical cells in which electrode terminals are arranged side by side; a battery accommodation casing that includes an accommodation portion accommodating the plurality of electrical cells and a cover portion blocking an opening of the accommodation portion; and a cooling device that supplies a cooling fluid between the plurality of electrical cells accommodated in the accommodation portion from the opposite side to the surface provided with the electrode terminals, wherein the battery accommodation casing is provided with a cooling fluid introduction port that introduces the cooling fluid into the accommodation portion and a first cooling fluid discharge port that discharges the cooling fluid from the accommodation portion to the outside, and wherein the cover portion that faces the accommodation portion is provided with a cooling fluid guide portion that substantially evenly guides the cooling fluid toward the electrode terminals of the plurality of electrical cells.

In the battery system of the present invention, the battery accommodation casing is provided with the cooling fluid introduction port which introduces the cooling fluid from the lower side (the opposite side to the surface provided with the electrode terminal) of the electrical cell into the gap between the adjacent electrical cells (“side space”), the cooling fluid guide portion which guides the cooling fluid to the electrode terminal in the cover portion facing the accommodation portion, and the first cooling fluid discharge port which discharges the cooling fluid guided to the electrode terminal by the cooling fluid guide portion to the outside of the battery accommodation casing.

Accordingly, the cooling fluid which passes between the electrical cells inside the battery accommodation casing becomes a flow directed toward the first cooling fluid discharge port through the terminal surface provided with the electrode terminal of the electrical cell by the cooling fluid guide portion, thereby sufficiently cooling the terminal surface provided with the electrode terminal of each electrical cell.

### Effects of the Invention

According to the battery system of the invention, it is possible to efficiently cool the terminal surface having the electrode terminal of each electrical cell.

### BRIEF DESCRIPTION OF DRAWINGS

FIG. 1 is a diagram illustrating a configuration example of a battery system according to a first embodiment of the present invention.

FIG. 2(a) is a diagram illustrating an example of a battery pack in a battery system according to the first embodiment of the present invention and is a cross-sectional view taken along the line A-A of FIG. 2(b), and FIG. 2(b) is a cross-sectional view taken along the line B-B of FIG. 2(a).

FIG. 3(a) is a cross-sectional view taken along the line C-C of FIG. 2(a), and FIG. 3(b) is a cross-sectional view taken along the line D-D of FIG. 2(b).

FIG. 4 is a diagram illustrating an accommodation portion side of a cover portion of a battery pack in the battery system according to the first embodiment.

FIG. 5 is a diagram illustrating an air current inside a battery accommodation casing configuring the battery pack in the battery system according to the first embodiment.

FIG. 6A (a) is a plan view illustrating an example of a battery pack in a battery system according to a second embodiment, and FIG. 6A (b) is a bottom view illustrating an example of a cover portion of the battery pack in the battery system according to the second embodiment.

FIG. 6B(c) is a plan view illustrating another example of the cover portion of the battery pack in the battery system according to the second embodiment, and FIG. 6B(d) is a plan view illustrating another example of the battery pack in the battery system according to the second embodiment.

FIG. 7(a) is a diagram illustrating an example of a battery pack in a battery system according to a third embodiment and is a cross-sectional view taken along the line E-E of FIG. 7(b), and FIG. 7(b) is a cross-sectional view taken along the line F-F of FIG. 7(a).

FIG. 8(a) is a diagram illustrating an accommodation portion side of a cover portion of the battery pack in the battery system according to the third embodiment, and FIG. 8(b) is a diagram illustrating a modified example of the accommodation portion side of the cover portion.

FIG. 9 is a diagram illustrating an example of a battery pack configuring a battery system according to a fourth embodiment.

FIG. 10(a) is a side view of FIG. 9, and FIG. 10(b) is a cross-sectional view taken along the line G-G of FIG. 9.

FIG. 11(a) is a diagram illustrating an example of a battery pack in a battery system according to a fifth embodiment and is a cross-sectional view taken along the line H-H of FIG. 11(b), and FIG. 11(b) is a plan view of FIG. 11(a).

FIG. 12(a) is a diagram illustrating a modified example of the first embodiment, and FIG. 12(b) is a plan view of FIG. 12(a).

### DESCRIPTION OF EMBODIMENTS

### First Embodiment

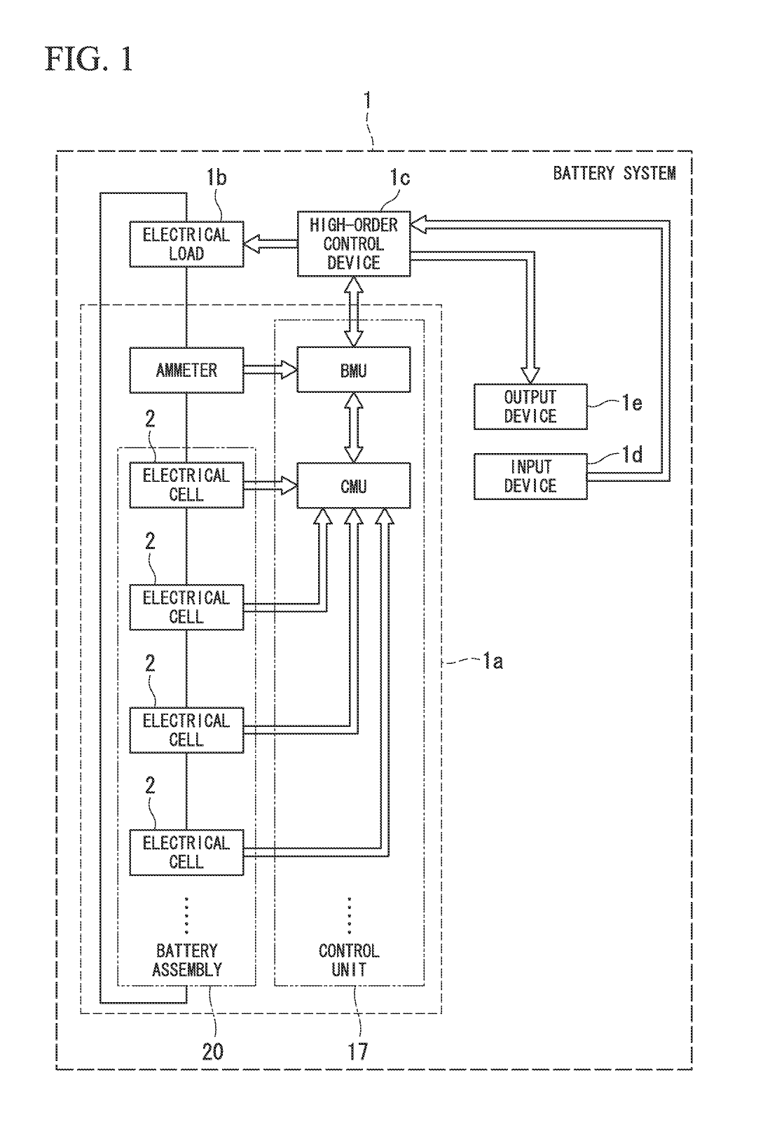

Hereinafter, a battery system and a battery pack which is included in the battery system according to a first embodiment of the present invention will be described by referring to FIGS. 1 to 4.

As illustrated in FIG. 1, a battery system 1 of the embodiment includes a battery assembly 20 which includes a plurality of electrical cells 2, a control unit 17 which includes a CMU and a BMU, an electrical load 1b, a high-order control device 1c, an input device 1d, and an output device 1e.

The battery system 1 is, for example, an industrial vehicle, an electric vehicle, a hybrid vehicle, a train, a ship, an airplane, a stationary electrical storage device, or the like, and is collectively referred to as a system which is driven by receiving electrical power from one or a plurality of electrical cells. In the following description, the electric vehicle will be described as an example of the battery system 1.

The electrical cell 2 has a structure in which electrode plates (a positive electrode plate and a negative electrode plate) (not illustrated) are accommodated inside a substantially square battery can with a separator interposed therebetween. As the electrical cell 2, for example, a lithium ion secondary battery may be exemplified. As the lithium ion secondary battery to which the invention is applicable, the invention is not limited to the stacking type battery in which a plurality of positive electrode plates and a plurality of negative electrode plates are stacked with a separator interposed therebetween, and may be applied to a wrapping type battery in which a pair of positive and negative electrode plates are wrapped inside a battery can with a separator interposed therebetween.

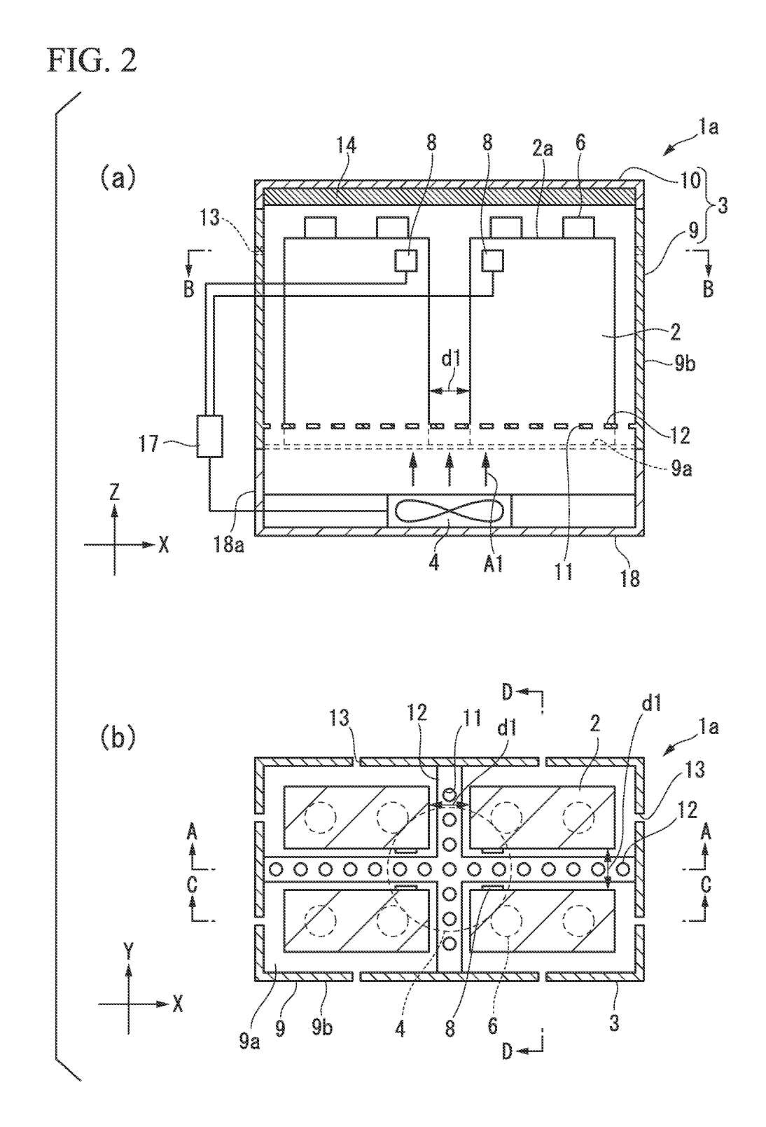

A plurality of combinations of the electrical cells 2 configure a battery assembly 20. The respective electrical cells 2 are connected in series or in parallel to each other by an electric connection member (an interconnection, a busbar, or the like to be described later), and are accommodated inside a battery accommodation casing 3 (to be described later in detail by using FIG. 2). Furthermore, the connection of the respective electrical cells 2 in the battery assembly 20 may be any one of series connection, parallel connection, and a connection obtained by the combination of the series connection and the parallel connection. In the embodiment, the respective electrical cells 2 are connected in series to each other. Further, each electrical cell 2 is provided with a plurality of types of measurement sensors which measure a measurement value such as a voltage across the terminals of the electrical cell 2, a can potential, or a temperature.

Further, the value of a current which flows to the battery assembly 20 is measured by, for example, an ammeter which is provided between the battery assembly 20 and the electrical load 1b. The ammeter includes an ADC (Analog Digital Converter) (not illustrated), and is an electrical instrument which is used to measure a current or the like output from the battery assembly 20 to the electrical load 1b (to be described later).

The electrical load 1b is a system or a device which is operated by receiving electrical power from the battery assembly 20 under the control of the control unit 17 and the high-order control device 1c (to be described later). For example, in the case of an electric vehicle, electrical machinery (an electric motor or the like) which is operated by receiving electrical power from the battery assembly 20 is exemplary examples.

The control unit 17 includes, for example, a CMU (Cell Monitor Unit) which monitors the value of a current obtained from the ammeter and flowing to the battery assembly 20 or the measurement value obtained from each electrical cell 2 by the measurement sensor and a BMU (Battery Management Unit) which manages each electrical cell 2 based on the measurement value obtained from the CMU.

The CMU includes an ADC (not illustrated). The ADC receives the measurement value which is detected by the plurality of types of measurement sensors (in the embodiment, a thermistor 8 to be described later) and is output as an analog signal, and converts the analog signal into a corresponding digital signal.

The CMU outputs measurement information based on the measurement value, which is converted into a digital signal by the ADC, to the BMU. Furthermore, in the embodiment, one CMU is provided for the plurality of electrical cells 2 (in the embodiment, four electrical cells 2), but may be provided so as to correspond one-to-one to the electrical cell 2 or may be integrated with the BMU by adding the function thereof to the BMU.

The BMU receives the measurement information from the CMU, and calculates a SOC (State of Charge), a SOH (State of Health), or the like based on the received measurement information. The CMU and the BMU are electrically connected to each other through a bus which transmits and receives data. Further, the BMU is connected to the high-order control device 1c which is mounted on the battery system 1 through a bus which transmits and receives data.

The high-order control device 1c is a control device such as an ECU (Electronic Control Unit) which is mounted on the electric vehicle as the battery system 1. The high-order control device 1c is connected to all of the electrical load 1b, the input device 1d, and the output device 1e to be described later through a bus, and performs overall control of the entire battery system 1 in addition to the control of the electrical load 1b.

Further, the high-order control device 1c performs, for example, control in which out putting the current value or the voltage value of the battery assembly 20 or the battery information based on the SOC or the SOH from the output device 1e based on the command which is input from a user of the electric vehicle through the input device 1d.

The input device 1d is a device which receives a command for outputting the battery information of the battery assembly 20 from a user. As the input device 1d, for example, the types of switches, a touch panel, or the like which are provided around the instrument panel of the electric vehicle may be adopted.

The output device 1e is a device which outputs the battery information of the battery assembly 20 visually or as audio, and in the case of the electric vehicle, a monitor for an instrument panel or a car-navigation, a speaker, or the like may be exemplified. Further, the information which is output to the output device 1e is not limited to the battery information, and the driving state or the magnitude of the air volume of the cooling fan 4 to be described later may be output therefrom.

In the embodiment, a battery pack 1a is configured by including the battery assembly 20 and the control unit 17 described above.

Next, the battery pack 1a which is included in the battery system 1 of the embodiment will be described in detail. In the following description, for convenience of description, the direction in which the electrode terminals 6 (the positive electrode terminal and the negative electrode terminal) of the electrical cell 2 are arranged in a straight line will be indicated by the X direction, the height direction of the electrical cell 2 will be indicated by the Z direction, and the direction which is perpendicular to the X and Z directions will be indicated by the Y direction with reference to the X axis, the Y axis, and the Z axis which are perpendicular to each other.

As illustrated in FIGS. 2(a) and 2(b), the battery pack 1a according to the embodiment includes the plurality of electrical cells 2 which configure the battery assembly 20, the battery accommodation casing 3 which accommodates the electrical cells 2, the cooling fan 4 which serves as a cooling device supplying a cooling fluid A1 to the electrical cell 2 accommodated inside the battery accommodation casing 3, and the control unit 17 which controls the driving of the cooling fan 4 and monitors the temperature, the voltage across terminals, or the like of the electrical cell 2. Furthermore, for convenience of description, the interconnection formed between each of the respective electrical cells 2 and the interconnection formed between each electrical cell 2 and the control unit 17 are omitted from the drawings.

The terminal surface 2a of each electrical cell 2 is provided with the electrode terminal 6 (the positive electrode terminal or the negative electrode terminal) which protrudes toward the positive side in the Z direction from the battery can. In this way, the battery accommodation casing 3 includes the terminal surface 2a, which at least one surface of which is provided with the electrode terminal 6.

The plurality of electrical cells 2 are arranged two-dimensionally inside the battery accommodation casing 3 to be described later in detail so that the protruding directions of the respective electrode terminals 6 are aligned in the same direction. In the embodiment, four electrical cells 2 are arranged according to the matrix of two by two inside the battery accommodation casing 3, and a predetermined gap d1 is provided between the adjacent electrical cells 2. With regard to the plurality of electrical cells 2, for example, the electrode terminals 6 are connected to each other through an interconnection (not illustrated). Furthermore, the electrode terminals 6 of the plurality of electrical cells 2 may be connected to each other by the busbar to be described later in the fourth embodiment.

In the following description, the battery assembly 20 will be described on the assumption that the terminal surface 2a of each electrical cell 2 faces the upper side (the direction which is directed from the negative side toward the positive side on the Z axis, and the same applies to the following description), that is, the electrode terminal 6 protrudes upward.

As described above, each electrical cell 2 is provided with a plurality of types of measurement sensors, and in the first embodiment, the thermistor 8 which measures the temperature of each electrical cell 2 is used as an example of the measurement sensor. Although there is no particular limitation in the installation position of the thermistor 8 of each electrical cell 2, it is desirable that the thermistors be eccentrically installed at a position close to the center of the surface of the battery can in the electrical cells 2 so as to approach the center of the plurality of electrical cells 2 arranged inside the battery accommodation casing 3. Since the temperature of the center of the plurality of electrical cells 2 is easy to increase inside the battery accommodation casing 3, the thermistor may effectively determine the temperature of the portion.

Although it is not illustrated in the drawings, the thermistor 8 includes, for example, a temperature sensitive portion which has a thermistor element having a resistance value changing with a temperature and an external circuit portion which has a power supply and a detection resistance. Then, the temperature of the temperature sensitive portion is detected from the terminal voltage of the detection resistance which changes with a change in the resistance value (the analog signal) of the thermistor element, and the detected temperature information is transmitted to the control unit 17.

The control unit 17 performs control in which the cooling fan 4 to be described later is driven based on the temperature information which is acquired from the thermistor 8. Specifically, the control unit 17 acquires the temperature information from each thermistor 8 installed in each electrical cell 2 at a predetermined cycle, and cools the plurality of electrical cells 2 by driving the cooling fan 4 when detecting a state in which any one of the acquired temperatures becomes higher than or equal to a predetermined temperature. In this case, the control unit 17 may drive the cooling fan 4 based on the minimum temperature in the temperature information acquired from the respective thermistors 8 or may drive the cooling fan 4 based on the average value of the temperature information acquired from the respective thermistors 8.

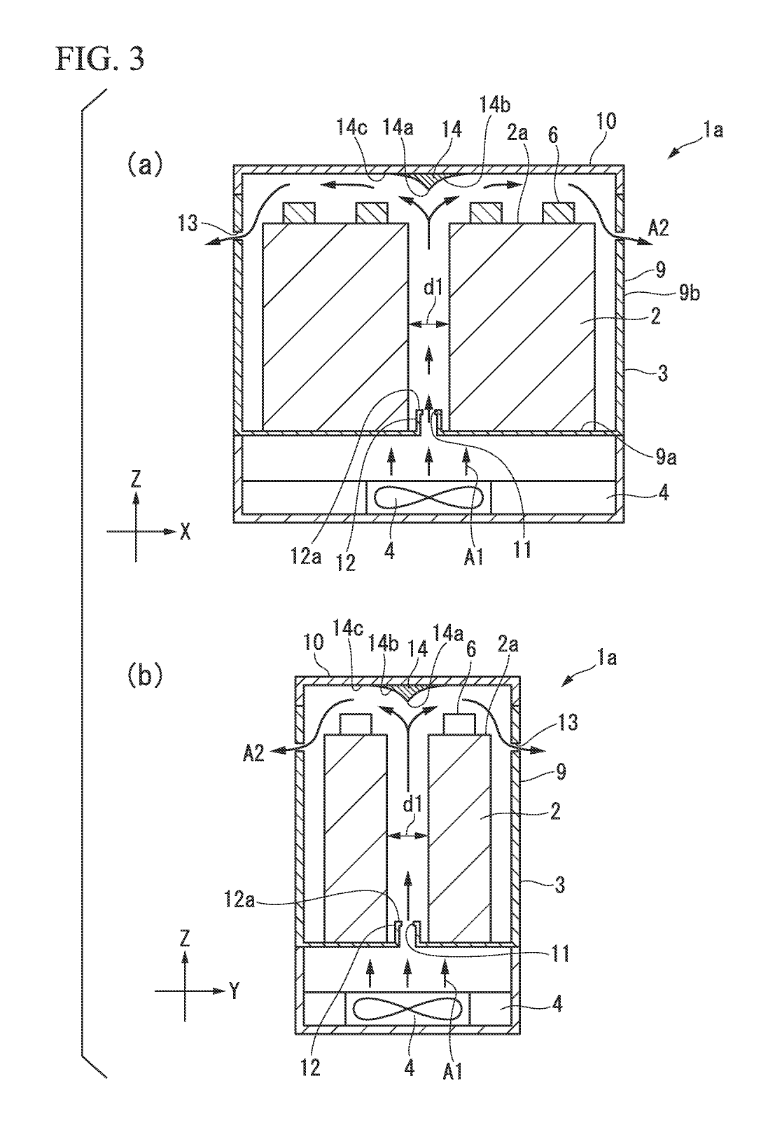

As illustrated in FIGS. 2 and 3, the control unit 17 of the embodiment is disposed outside the battery accommodation casing 3, and is fixed to the battery accommodation casing 3 through a fixing member (not illustrated). Furthermore, the arrangement pattern of the control unit 17 is not particularly limited. For example, the control unit 17 may be disposed inside the accommodation casing which is formed separately from the battery accommodation casing 3, and may be fixed to a side portion 9b of an accommodation portion 9 (to be described later) which configures the battery accommodation casing 3.

The cooling fan 4 of which the driving is controlled by the control unit 17 is disposed inside the accommodation casing 18 which is disposed below four electrical cells 2 arranged inside the accommodation portion 9 (in the direction from the negative side toward the positive side on the Z axis, and the same applies to the following description). The accommodation casing 18 is a concave casing with an opening, and the planar shape in the Z direction is substantially the same as that of the battery accommodation casing 3. The accommodation casing 18 is connected to the battery accommodation casing 3 by known fixing means (an adhesive, a bolt, or the like) so that the above-described opening matches the bottom portion 9a of the accommodation portion 9.

The cooling fan 4 supplies the cooling fluid A1 toward the plurality of electrical cells 2 which are present thereabove through the above-described opening. As for the cooling fluid, there is no particular limitation, and for example, an inert gas such as air, carbon gas, or nitrogen gas are exemplary examples. In the embodiment, air (hereinafter, referred to as “cooling air A1”) as the cooling fluid A1 blows from the cooling fan 4.

The cooling fan 4 is electrically connected to the control unit 17 through an interconnection (not illustrated) inside the accommodation casing 18. Further, electrical power which is necessary for driving the cooling fan 4 is supplied from the electrical cell 2 to the cooling fan, and the driving of the cooling fan is controlled by the above-described control unit 17.

Furthermore, in the present invention, the battery pack 1a does not need to be essentially provided with the cooling fan 4. For example, the cooling air may supplied from the other air blowing mechanism, which is installed in the electric vehicle battery system provided with the battery pack 1a, into the battery pack 1a.

Further, in the embodiment, although the accommodation casing 18 and the battery accommodation casing 3 are formed separately from each other, these components may be integrated with each other so that the cooling fan 4 is accommodated below the battery accommodation casing 3.

Further, in the embodiment, although the control unit 17 is disposed outside the battery accommodation casing 3, the present invention is not limited thereto. The control unit 17 may be disposed inside the battery accommodation casing 3 or the accommodation casing 18.

Next, the detailed structure of the battery accommodation casing 3 in the battery pack 1a of the embodiment will be described.

As illustrated in FIGS. 2 and 3, the battery accommodation casing 3 is a substantially square container of which the upper portion is opened, and includes an accommodation portion 9 which accommodates the plurality of electrical cells 2 and a cover portion 10 which blocks the above-described opening of the accommodation portion 9. The accommodation portion 9 and the cover portion 10 are respectively formed of, for example, metal such as aluminum or a resin such as plastic.

The accommodation portion 9 includes a bottom portion 9a and a side portion 9b, and a step portion 12 is formed in the bottom portion 9a between the adjacent electrical cells 2. In the embodiment, since the accommodation portion 9 accommodates four electrical cells 2, the step portion 12 is formed in a cross shape (see FIG. 2(b)) in the plan view from the Z direction.

The step portion 12 is provided with a cooling fluid introduction port 11 as a portion which introduces the cooling air A1 from the cooling fan 4. Specifically, a plurality of the cooling fluid introduction ports 11 are formed with a predetermined gap therebetween so as to form a cross shape along the step portion 12, and are not provided at the outer peripheral edge side of the bottom portion 9a of the accommodation portion 9 (the side surface of the electrical cell 2 and the side portion 9b of the accommodation portion 9) as illustrated in FIG. 2(b). That is, the plurality of cooling fluid introduction ports 11 are provided in a region which is interposed between the side surfaces of the adjacent electrical cells 2 in the step portion 12 in the plan view from the Z direction. As described below, in the embodiment, since the cooling air flows from the center of the battery accommodation casing 3 toward the outer peripheral edge, there is a need to prevent interference with the flow of the cooling air.

As illustrated in FIG. 3(a), the top surface 12a of the step portion 12 are formed so that its position is higher than that of the bottom portion 9a provided with the electrical cell 2 in the Z direction. Accordingly, the step portion 12 serves as a positioning guide when the plurality of electrical cells 2 are disposed so as to be accommodated inside the accommodation portion 9. On the other hand, the inside of the step portion 12 is formed in a hollow shape, and is formed in a concave shape when seen from the cooling fan 4 (the negative side in the Z direction). A plurality of the cooling fluid introduction ports 11 are provided in the top surface 12a of the step portion 12.

Furthermore, in the embodiment, the plurality of cooling fluid introduction ports 11 are formed as circular holes, but may be formed in an oval shape or may be formed as oval slits so that each of them is provided between the side surfaces of the adjacent electrical cells 2.

On the other hand, each side portion 9b of the accommodation portion 9 is provided with a plurality of cooling fluid discharge ports (first cooling fluid discharge ports) 13 which discharge air A2 inside the battery accommodation casing 3. The air A2 is, for example, air which is present inside the accommodation portion 9 or the cooling air A1 which is used for the heat exchange with the respective portions of the electrical cell 2. That is, at first when the driving of the cooling fan 4 is started under the control of the control unit 17, the air which is present inside the accommodation portion 9 is first discharged from the cooling fluid discharge port 13. Then, after a certain time elapses after the cooling fan 4 is driven, the cooling air A1 which is introduced into the accommodation portion 9 by the cooling fan 4 is discharged from the cooling fluid discharge port 13.

The cooling fluid discharge port 13 is a circular hole which penetrates each side portion 9b, and is evenly provided at, for example, two positions of each side portion 9b of the accommodation portion 9. Then, as illustrated in FIG. 3, the position of the cooling fluid discharge port 13 in the Z direction is above the position corresponding to ½ of the height (the position of the top surface of the electrode terminal 6 in the positive side in the Z direction with respect to the bottom portion 9a) of the electrical cell 2, and is positioned slightly below the terminal surface 2a of the electrical cell 2.

Since the cooling fluid discharge port 13 is installed at the side portion 9b of the accommodation portion 9, the cooling fluid discharge port does not overlap the cooling fluid introduction port 11 in the perpendicular (Z) direction. For this reason, the cooling air A1 which blows from the cooling fan 4 and enters into the accommodation portion 9 through the cooling fluid introduction port 11 does not directly come out to the outside of the battery accommodation casing 3. In other words, with regard to the cooling air A1 which enters into the battery accommodation casing 3 from the cooling fluid introduction port 11, the direction of the cooling air is changed in the cover portion 10, and the cooling air is introduced into the electrode terminal 6 of each electrical cell 2 and the upper side thereof. Accordingly, it is possible to efficiently cool the electrode terminal of each electrical cell 2 having a large amount of generated heat and the upper side thereof.

Furthermore, the cooling fluid discharge port 13 may not be provided in all side portions 9b of the accommodation portion 9, and may be provided only in the pair of opposite side portions 9b. For example, in a case where the plurality of battery packs 1a are arranged in series, when the cooling fluid discharge ports 13 of the adjacent battery packs 1a face each other, the air A2 which is discharged from each battery pack 1a collides with the air of the other battery pack, whereby the air A2 may not be efficiently discharged from the inside of the battery pack 1a. Thus, in such a case, it is desirable that the cooling fluid discharge port 13 be provided in the pair of side portions 9b on the side which is not adjacent to the other battery pack 1a. Further, the position of the cooling fluid discharge port 13 may be set in consideration of the gap or the like between the arranged battery packs 1a. That is, when the gap between the plurality of battery packs 1a is sufficiently wide and the air A2 discharged from the cooling fluid discharge port 13 does not interfere with the air of the other battery pack between the adjacent battery packs 1a, the cooling fluid discharge port 13 may be provided in each side portion 9b of each accommodation portion 9.

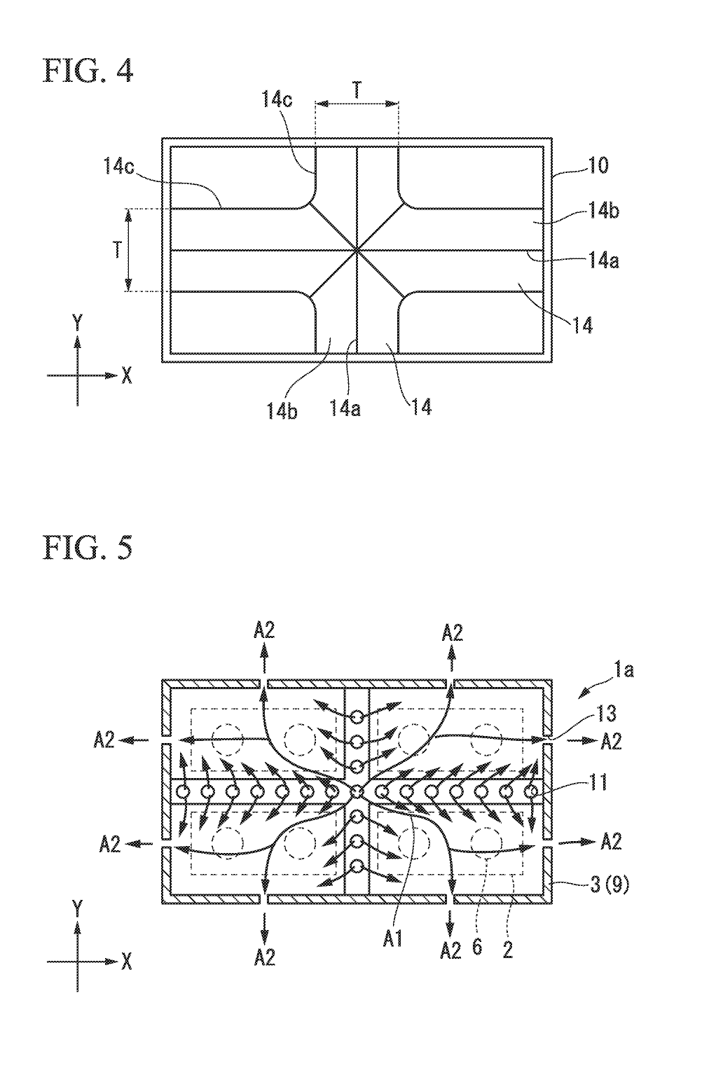

As illustrated in FIGS. 3 and 4, the cover portion 10 is provided with a cooling air guide portion (a cooling fluid guide portion) which guides the cooling air A1 introduces from the cooling fluid introduction port 11 into the accommodation portion 9 to the electrode terminal 6 of the electrical cell 2 and the upper side thereof. In the embodiment, as the cooling air guide portion, a protrusion portion 14 which protrudes toward the accommodation portion 9 faces the accommodation portion 9 in the cover portion 10. The protrusion portion 14 is formed at a position corresponding to the upper side of the side space which is formed by the gap d1 between the adjacent electrical cells 2 in the surface near the accommodation portion 9 in the cover portion 10.

The protrusion portion 14 includes a side surface 14b of which the width of the cross-section (the cross-section based on the surface parallel to the XY plane) is widened from the front end 14a toward the cover portion 10. More specifically, with regard to the side surface 14b of the protrusion portion 14, the width of the cross-section in the X direction from the front end 14a toward the skirt portion 14c near the cover portion 10 is gradually widened in FIG. 3(a), and the width of the cross-section in the Y direction from the front end 14a toward the cover portion 10 is gradually widened in FIG. 3(b).

The height of the front end 14a of the protrusion portion 14 in the Z direction is not particularly limited, however, it is desirable that the front end be positioned above the electrode terminal 6 of the electrical cell 2 in the Z direction. This is because the side surface 14b of the protrusion portion 14 may be prevented from interfering with the electrode terminal 6 or the busbar (not illustrated).

Furthermore, the protrusion portion 14 which is formed on the cover portion 10 may be integrally formed with the cover portion 10 or may be formed as a member different from the cover portion 10. When the protrusion portion 14 is integrally formed with the cover portion 10, the protrusion portion is formed by, for example, injection molding.

The side surface 14b of the protrusion portion 14 may be curved from the front end 14a toward the cover portion 10 or may be formed in a planar shape.

Further, as illustrated in FIG. 4, the protrusion portion 14 of the embodiment is formed in a cross shape within the cover portion 10 in the plan view from the Z direction. Furthermore, it is desirable that the length T which defines the gap between the skirt portions 14c of the protrusion portion 14 be larger than the gap d1 of the adjacent electrical cells 2. Accordingly, it is possible to prevent a problem in which the cooling air A1 which is guided by the side surface 14b of the protrusion portion 14 is reflected in the cover portion 10 and is returned to the side space of the electrical cell 2.

Next, the operation and the effect of the battery pack 1a which is included in the battery system 1 of the embodiment will be described.

When the battery system 1 is operated and the battery assembly 20 inside the battery pack 1a performs charging and discharging, the control unit 17 acquires the temperature information at a predetermined cycle from the respective thermistors 8 which are installed in the respective electrical cells 2 configuring the battery assembly 20.

When the control unit 17 detects that the temperature information acquired from, for example, one or more thermistors 8 is higher than or equal to the above-described set temperature (for example, 40° C.), the control unit transmits the driving signal driving the cooling fan 4 to the cooling fan 4.

Then, when the cooling fan 4 which receives the driving signal is driven, the cooling air A1 is introduced from the cooling fan 4 into the battery accommodation casing 3 through the cooling fluid introduction port 11. At this time, it is desirable that the high-order control device 1c perform control in which information on the driving state of the cooling fan 4 (for example, the state of the cooling fan 4 regarding the air volume or the ON/OFF state of the cooling fan) is acquired from the control unit 17 and the driving state of the cooling fan 4 is output to the output device 1e. Accordingly, a user (for example, a driver of an electric vehicle) may more appropriately recognize the state of each electrical cell 2 inside the battery pack 1a.

Hereinafter, the flow of the cooling air A1 which is introduced from the cooling fluid introduction port 11 into the battery accommodation casing 3 will be described in detail.

First, the cooling air A1 which blows from the cooling fan 4 is guided to the step portion 12, passes through the cooling fluid introduction ports 11, and is introduced into the battery accommodation casing 3 upward.

On the other hand, the cooling air A1 which is introduced into the battery accommodation casing 3 comes out of the side space present between the adjacent electrical cells 2 and moves to the upper side of the accommodation portion 9. Furthermore, when the cooling air A1 passes through the side space, a heat exchange is performed between the side surfaces of the electrical cells 2, so that the side surface of the electrical cell 2 is cooled.

Subsequently, the cooling air A1 which passes through the side space reaches the cover portion 10 of the battery accommodation casing 3.

In the embodiment, the protrusion portion 14 which serves as the cooling air guide portion is provided near the accommodation portion 9 in the cover portion 10. Thus, the cooling air A1 which reaches the cover portion 10 is guided by the side surface 14b of the protrusion portion 14 so that the flow of the air changes toward the terminal surface 2a with the electrode terminal 6 of the electrical cell 2 and the upper side of the terminal surface. As described above, since the protrusion portion 14 which is formed in the cover portion 10 is formed in a cross shape in the plan view from the Z direction, the cooling air A1 is substantially evenly dispersed toward the upper side of each electrical cell 2.

Subsequently, the cooling air A1 performs a heat exchange between the electrode terminal 6 and the terminal surface 2a when passing by the terminal surface 2a of the electrode terminal 6 of each electrical cell 2 and the upper side thereof, so that the terminal surface 2a with the electrode terminal 6 of the electrical cell 2 is cooled.

The cooling air A1 which passes by the terminal surface 2a with the electrode terminal 6 and the upper side thereof is continuously discharged from the cooling fluid discharge port 13 formed in the side portion 9b of the accommodation portion 9 toward the outside of the battery pack 1a.

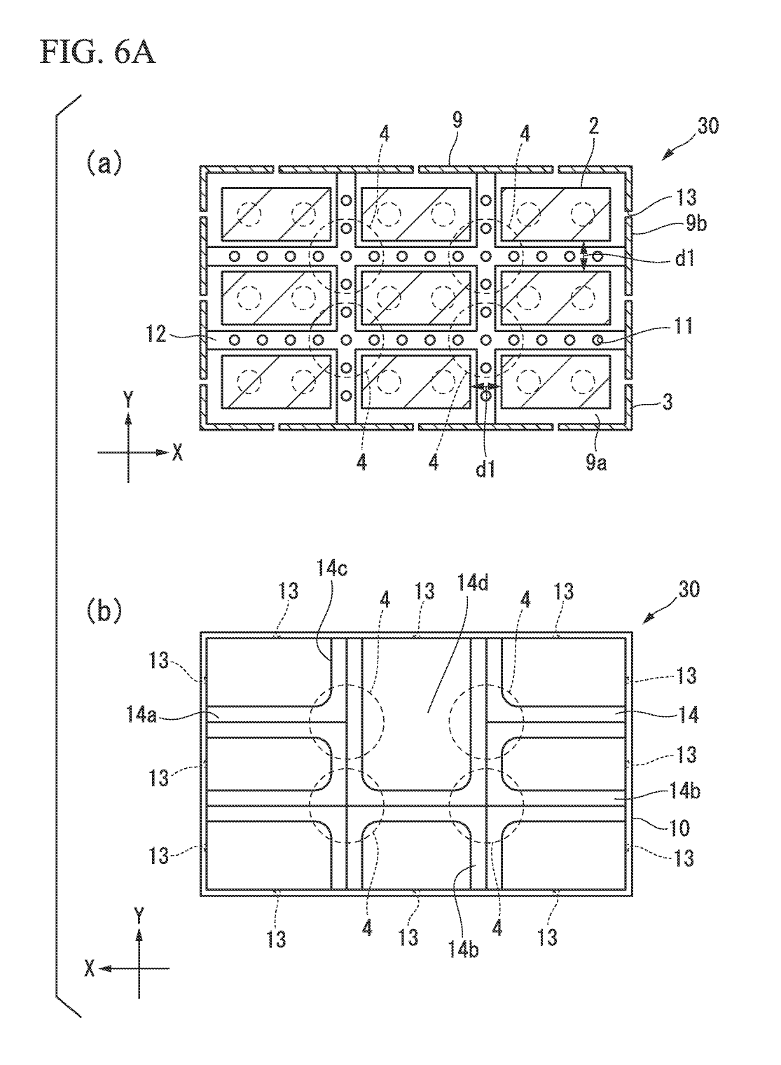

In this way, the cooling air A1 which blows from the cooling fan 4 is introduced from the cooling fluid introduction port 11 into the accommodation portion 9 inside the battery accommodation casing 3, performs a heat exchange between the respective portions of the electrical cell 2 (the side surface, the electrode terminal 6, the terminal surface 2a, or the like), and then is discharged from the cooling fluid discharge port 13 to the outside of the battery accommodation casing 3. At this time, as depicted by the arrow of FIGS. 3 and 5, the air current which is formed by the cooling air A1 becomes a flow which is directed from the cooling fluid introduction port 11 toward the upper side and is directed toward the cooling fluid discharge port 13 in the substantially horizontal direction along the side surface 14b of the protrusion portion 14 provided in the cover portion 10 (at this time, there is a need to make sure that the cooling air A1 substantially evenly flows to the respective electrical cells 2).

Furthermore, it is desirable that the air A2 (including the cooling air A1) which is discharged from the cooling fluid discharge port 13 to the outside of the battery accommodation casing 3 be discharged to the outside of the battery system 1 by, for example, a fan or the like (not illustrated) separately installed outside the battery accommodation casing 3.

According to the battery system 1 which includes the battery pack 1a according to the above-described first embodiment, the following effect may be obtained.

That is, when the battery assembly 20 included in the battery pack 1a is cooled, it is important to consider how the top surfaces of the respective electrical cells 2 (the terminal surface 2a including the electrode terminal 6) are evenly cooled.

In this case, for example, a configuration may be considered in which a plurality of the cooling fans 4 are provided and one cooling fan 4 is provided above the side portion 9b of the accommodation portion 9 so as to cool the top surface of the electrical cell 2. However, simply by providing the plurality of cooling fans 4, an increase in the cost is caused, and also an increase in the size of the battery pack 1a is caused, whereby it is difficult to satisfy the demands on the design and specification in order that the electrical cell 2 be charged in a maximally dense state in a limited space. In particular, in a case where the battery system 1 is an electric vehicle, the space used for mounting the battery pack 1a therein is limited, which may be regarded as one factor which hinders improvement in the product quality if the above-described demand cannot be satisfied.

Furthermore, for example, a configuration may be considered in which a certain guide mechanism is provided in the side portion 9b of the accommodation portion 9 so as to adjust the flow of the cooling air A1 in the side space. Although a certain effect may be expected since heat is naturally generated in the side of the electrical cell, simply adjusting the cooling air flowing to the side space of the electrical cell by guiding the cooling air cannot be considered to be an effective solving method from the viewpoint that the top surfaces of the respective electrical cells need to be evenly cooled.

On the other hand, according to the battery system 1 with the battery pack 1a of the first embodiment, the cover portion 10 includes the protrusion portion 14 which serves as the cooling air guide portion. Accordingly, the cooling air A1 which passes through the side space present between the adjacent electrical cells 2 and reaches the upper side inside the battery accommodation casing 3 moves to the cooling fluid discharge port 13 formed in the side portion 9b of the accommodation portion 9 along the terminal surface 2a of each electrical cell 2. Thus, since it is possible to form the flow of the cooling air A1 which is similar to the flow formed by the plurality of cooling fans 4 by using the single cooling fan 4 inside the battery accommodation casing 3, it is possible to efficiently cool the terminal surface 2a of the electrical cell 2 including the electrode terminal 6.

Further, the cooling air A1 which is guided by the protrusion portion 14 evenly (substantially evenly) becomes a flow directed toward the plurality of electrical cells 2 arranged inside the accommodation portion 9.

Accordingly, it is possible to realize a battery system capable of more evenly cooling the heat generated from the terminal surface 2a including the electrode terminal 6 of each electrical cell 2 while avoiding an increase in the size and cost of the battery pack a.

In addition to the above-described configuration, it is desirable that the position of each cooling fluid discharge port 13 formed in the side portion 9b of the accommodation portion 9 in the Z direction be slightly above ½ of the height of the electrical cell 2 and slightly below the terminal surface 2a of the electrical cell 2. Accordingly, since the cooling fluid discharge port 13 is present below at least the terminal surface 2a, the cooling air A1 which is introduced from the cooling fluid introduction port 11 is not directly directed toward the cooling fluid discharge port 13, but is directed toward the cooling fluid discharge port 13 after the heat exchange in the terminal surface 2a including the electrode terminal 6. Furthermore, since the cooling fluid discharge port 13 is positioned above ½ of the height of the electrical cell 2, it is possible to suppress the lower side of the electrical cell 2 from being heated by the cooling air A1 subjected to the heat exchange.

Further, the cooling air guide portion which is formed in the cover portion 10 (the same applies to the following embodiments) may serve to reinforce the cover portion 10. That is, the structural strength of the cover portion 10 may be relatively insufficient from the structural viewpoint of the battery accommodation casing 3. For example, in a case where the battery pack 1a is mounted on the electric vehicle as the battery system, the cover portion 10 may be deformed due to vibration, heat, or the like which is applied from the outside according to the use environment. At this time, the cooling air guide portion which is formed in the cover portion 10 serves as a rib, thereby effectively preventing the deformation of the cover portion 10 caused by vibration, heat, or the like.

Next, the other exemplary embodiments of the invention will be described with reference to the accompanying drawings, and the same reference numerals will be given to the member and the portion which are identical or similar to those of the above-described first embodiment, and the description thereof will not be repeated here. Thus, the configuration different from that of the first embodiment will be mainly described.

### Second Embodiment

The difference between the second embodiment and the first embodiment to be described later is that the number of the electrical cells 2 arranged inside the battery accommodation casing 3 of the battery pack is different and the configurations of the cooling fan 4, the cooling fluid introduction port 11, and the cooling fluid discharge port 13 are different. Then, the other configurations are the same as those of the first embodiment.

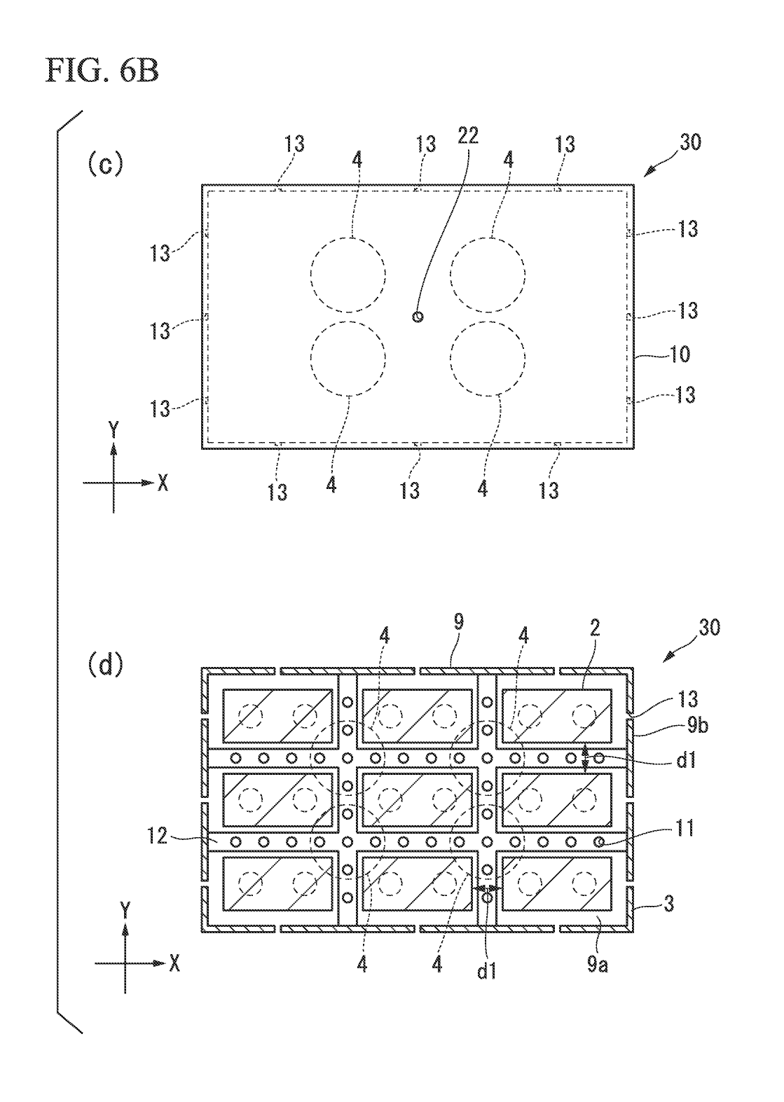

As illustrated in FIG. 6A (a), in a battery pack 30 according to the second embodiment, the electrical cells 2 are arranged in a three by three matrix inside the battery accommodation casing 3. Then, a plurality of the cooling fluid introduction ports 11 are provided at a position corresponding to the lower side of the side space formed by the gap d1 between the adjacent electrical cells 2 in the bottom portion 9a of the accommodation portion 9. As in the first embodiment, the cooling fluid introduction ports 11 are not provided at the outer peripheral edge side of the bottom portion 9a of the accommodation portion 9 (a region facing the side surface and the side portion 9b of the accommodation portion 9 in the electrical cell 2).

Cooling fans 4 are provided at four positions below the intersection positions of the respective rows formed by the plurality of cooling fluid introduction ports 11. In other words, the cooling fans 4 are respectively disposed at the positions corresponding to the center of four adjacent electrical cells 2 in the plan view from the Z direction.

A plurality of the cooling fluid discharge ports 13 are provided in the respective side portions 9b of the accommodation portion 9 so as to correspond to at least one of the respective electrical cells 2. Furthermore, when the cooling air A1 is maintained so as to be substantially evenly dispersed toward the terminal surface 2a of each electrical cell 2 and to be discharged to the outside of the battery pack, the number or the positions of the cooling fluid discharge ports 13 respectively formed in the respective side portions 9b are not particularly limited (the same applies to the other embodiments). That is, the cooling fluid discharge port 13 may be formed in the side portion 9b (so that the cooling air A1 which is substantially evenly distributed with respect to the respective electrical cells 2 is not disturbed) so as to correspond to the volume or the like of the cooling air A1 which is dispersed toward the respective electrical cells 2 by the cooling air guide portion. Thus, the cooling fluid discharge port 13 may be formed as a gap along the periphery of the side portion 9b (about the Z-axis) or may not be formed as a gap.

On the other hand, the protrusion portion 14 is provided in the cover portion 10 as in the first embodiment, but in the embodiment, in particular, the protrusion portion 14 is provided with a notched portion 14d. FIG. 6A(b) illustrates the cover portion 10 which is used in the embodiment. Furthermore, for convenience of description, the cooling fans 4 are also illustrated in FIG. 6A(b) so as to clarify the positional relationship between the cooling fans 4 and the protrusion portion 14. As illustrated in the same drawing, the cover portion 10 near the accommodation portion 9 is provided with the protrusion portion 14 which corresponds to the cooling fluid introduction port 11 in the plan view from the bottom side of the Z direction. In the protrusion portion 14, the notched portion 14d is formed in part of a region which surrounds the cooling fan 4 in the plan view from the Z direction. Further, as illustrated in FIG. 6A(a), the cooling fluid introduction port 11 is not formed at a position corresponding to the notched portion 14d in the top surface 12a of the step portion 12.

In this way, the reason why the cooling fluid introduction port 11 is not partly formed and the notched portion 14d is formed in the protrusion portion 14 is as follows.

That is, in the second embodiment, the battery pack 30 includes the plurality of (four) cooling fans 4. Thus, when the cooling air A1 which is introduced into the battery accommodation casing 3 by the respective cooling fans 4 reaches the cover portion 10, the cooling air A1 which undergoes the heat exchange with the side surface of the electrical cell 2 may stay in a region which is surrounded by the plurality of cooling fans 4 in the plan view from the Z direction.

In contrast, in the embodiment, the protrusion portion 14 is provided with the above-described notched portion 14d and the cooling fluid introduction port 11 is not formed at a position corresponding to the notched portion 14d. Accordingly, the cooling air A1 does not stay in a region surrounded by the plurality of cooling fans 4 in the plan view from the Z direction. That is, the cooling air A1 which arrives in the region surrounded by the cooling fans 4 in the cover portion 10 is finally discharged from the cooling fluid discharge port 13 formed in the side portion 9b to the outside of the battery accommodation casing 3 through the notched portion 14d. At this time, since the cooling fluid introduction port 11 is not formed at a position corresponding to the notched portion 14d, it is possible to suppress the flow of the cooling air A1 which arrives in the region surrounded by the cooling fans 4 from being disturbed.

In this way, in the plan view from the lower side of the Z direction in the cover portion 10 near the accommodation portion 9, at least one cooling fluid discharge port 13 is present in the entire region defined by the protrusion portion 14, and the cooling air A1 does not stay in any defined region.

Furthermore, as shown in FIG. 6B (c), instead of the notched portion 14d of FIG. 6A (b), a cover portion side cooling fluid discharge port (a second cooling fluid discharge port) 22 which penetrates the cover portion 10 may be provided at a position surrounded by four fans 16 in the cover portion 10 in the plan view from the Z direction. In this case, as shown in FIG. 6B (d), the cooling fluid introduction port 11 which is removed so as to correspond to the notched portion 14d may be formed.

Even when the cover portion side cooling fluid discharge port 22 is provided in the cover portion 10, the remaining cooling air A1 may be discharged from the cover portion side cooling fluid discharge port 22 to the outside of the battery pack 30.

According to the battery system with the battery pack 30 of the second embodiment described above, the same effect as that of the first embodiment may be obtained by forming the cooling fan 4, the cooling fluid introduction port 11, and the notched portion 14d according to the arrangement of the electrical cells 2. Further, the same effect as that of the first embodiment may be obtained even when the cover portion 10 is provided with the second cooling fluid discharge port 22 instead of the notched portion 14d.

In addition, since the notched portion 14d or the cover portion side cooling fluid discharge port 22 is provided at a position corresponding to the region surrounded by four cooling fans 4 in the cover portion 10, it is possible to suppress the cooling air A1 from remaining in a region surrounded by four cooling fans 4 inside the battery accommodation casing 3. Accordingly, it is possible to prevent the accumulation of heat at the region, and hence to realize a battery system having an excellent heat radiation performance.

### Third Embodiment

Next, a third embodiment will be described by referring to the drawings.

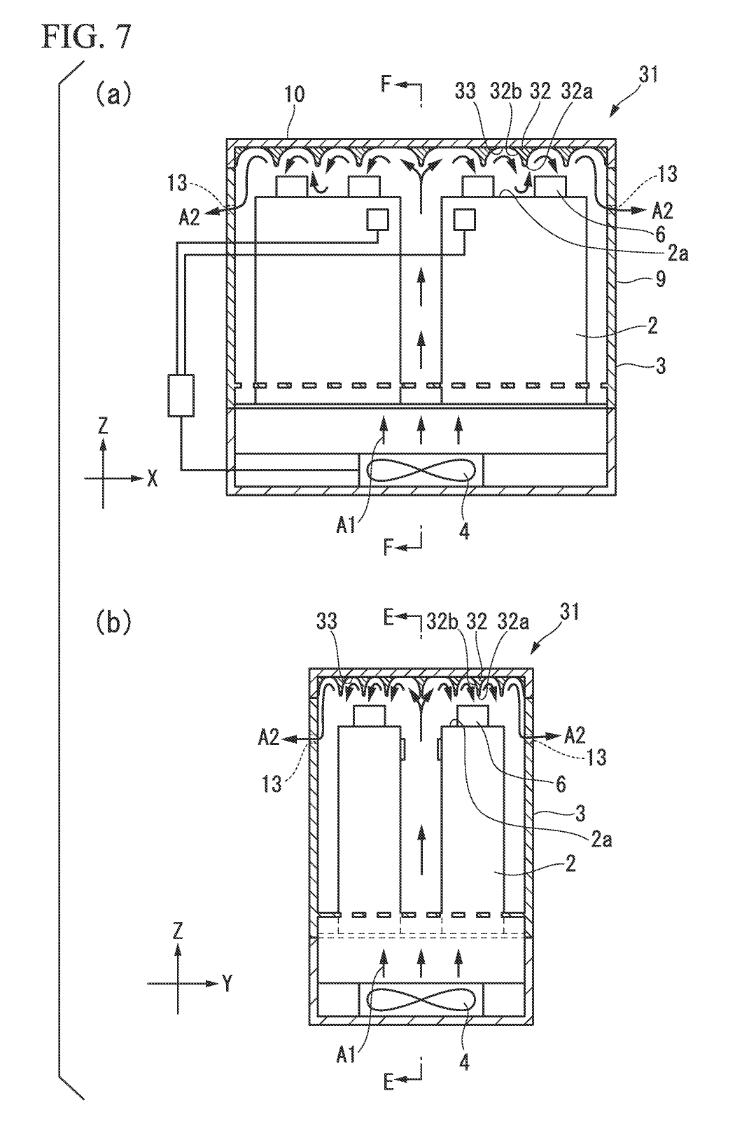

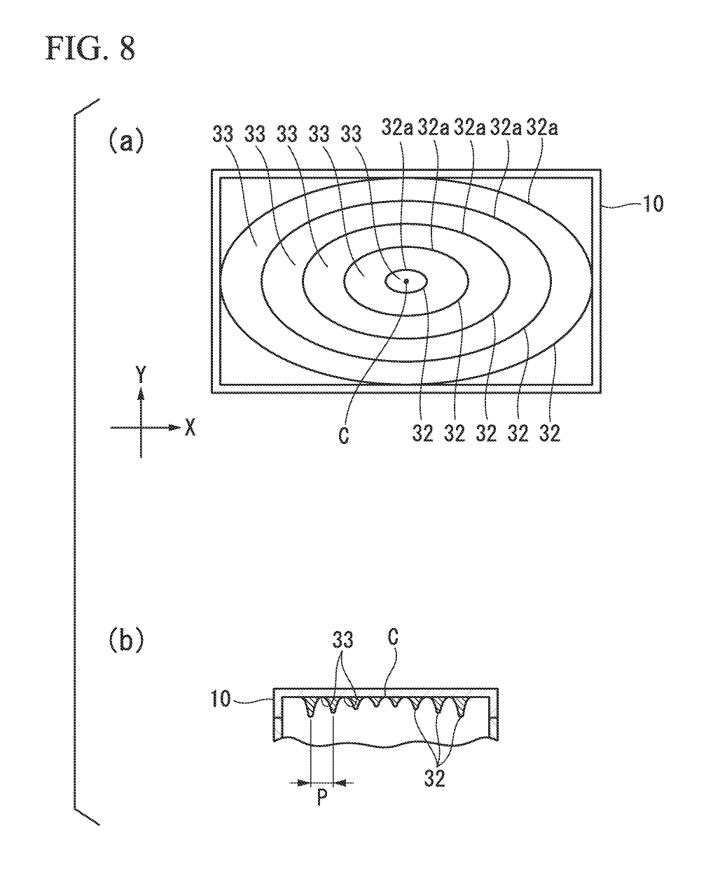

The third embodiment illustrates a modified example of the cooling air guide portion of the first embodiment. As illustrated in FIGS. 7 and 8(a), in a battery pack 31 according to the third embodiment, the surface of the cover portion 10 near the accommodation portion 9 is provided with a plurality of concentric oval protrusion portions 32 as cooling air guide portions. The respective protrusion portions 32 are formed so as to protrude from the cover portion 10 toward the accommodation portion 9 so that the centers of the protrusion portions 32 are substantially coaxial with each other in the plan view from the Z direction. Further, the centers of the respective protrusion portions 32 are set so as to substantially match the centers of the plurality of arranged electrical cells 2 in the plan view from the Z direction.

Each protrusion portion 32 is formed so that the cross-section in the radial direction (the direction parallel to the XY plane) is widened from the front end 32a toward the cover portion 10. A side surface 32b of the protrusion portion 32 is curved, and a concave portion 33 of which the radial cross-section is substantially formed in an arc shape is formed between the adjacent protrusion portions 32.

Such the protrusion portion 32 has a function of generating a turbulent flow in addition to the function of guiding the cooling air A1. That is, the cooling air A1 which is introduced from the cooling fluid introduction port 11 into the accommodation portion 9 is first guided by the protrusion portion 32 positioned at the center in the cover portion 10 toward the terminal surface 2a of the electrical cell 2. Subsequently, the cooling air A1 is reflected in the terminal surface 2a toward the upper side of the electrical cell 2, and is blown against the protrusion portion 32 (the protrusion portion 32 on the outside of the protrusion portion 32 positioned at the center) again.

At this time, most of the reflected cooling air A1 blows against the protrusion portion 32 which is positioned near the protrusion portion 32 that is positioned at the center. Then, since the plurality of protrusion portions 32 are respectively provided with the concave portions 33, the cooling air A1 which blows against the protrusion portion 32 is guided toward the terminal surface 2a again. In this way, the cooling air A1 of the embodiment becomes a turbulent flow which is repeatedly reflected between the protrusion portion 32 and the electrical cell 2, and is gradually guided toward the cooling fluid discharge port 13 along the flow of the cooling air A1 which is sequentially blown by the cooling fan 4. At this time, the cooling air A1 cools the electrical cell 2 by performing a heat exchange with respect to the terminal surface 2a having the electrode terminal 6 of the electrical cell 2, and is discharged from the cooling fluid discharge port 13 to the outside of the battery pack 31.

According to the battery pack 31 of the third embodiment, since the cover portion 10 is provided with the plurality of concentric oval protrusion portions 32, the cooling air A1 which blows against the cover portion 10 is particularly guided by the concave portion 33 forming the protrusion portion 32 so as to flow downward and reach the terminal surface 2a of the electrical cell 2. Thus, it is possible to efficiently cool the terminal surface 2a having the electrode terminal 6 of the electrical cell 2, and obtain the same effect as that of the first embodiment.

In addition to such an effect, since the cooling air A1 becomes a turbulent flow while being repeatedly reflected between the protrusion portion 32 and the terminal surface 2a so as to be dispersed toward the cooling fluid discharge port 13, it is possible to perform a sufficient heat exchange with the top surface of each electrical cell 2 (the terminal surface 2a including the electrode terminal 6) and cool the broader region of the top surface of the electrical cell 2.

Furthermore, in the embodiment, although the cover portion 10 is provided with the plurality of concentric oval protrusion portions 32, a plurality of concentric circular protrusion portions, a plurality of concentric polygonal (triangular or square) protrusion portions, or the like may be provided instead of the plurality of concentric oval protrusion portions 32. Further, it is not necessary to continuously form the respective protrusion portions 32, and the protrusion portion 32 may be formed by intermittently arranging the columnar protrusions. That is, in the embodiment, a plurality of protrusion portions 32 which are substantially formed in a concentric circular shape (including the concentric oval shape and the concentric circular shape) may be provided in the cover portion 10.

FIG. 8(b) is a modified example of the plurality of protrusion portions 32 of the embodiment. As illustrated in the modified example, in the plurality of protrusion portions 32 which are substantially formed in a concentric circular shape, the positions of the protrusion portions 32 in the height direction (the Z direction) are different from each other. In the example, the plurality of protrusion portions 32 are formed in the cover portion 10 near the accommodation portion 9 so that the height of the protrusion portion 32 becomes higher (that is, becomes closer to the terminal surface 2a of the electrical cell 2) as it moves from the center C of the cover portion 10 toward the outside. Furthermore, although it is desirable that the pitch P between the front ends 32a of the adjacent two protrusion portions 32 is substantially the same in the plurality of protrusion portions 32, for example, the pitches P near the center C and the outside of the cover portion 10 may be different from each other.

Even in the modified example, the cooling air A1 may be guided to the terminal surface 2a of the electrical cell 2, and the cooling air A1 may be more efficiently guided to the cooling fluid discharge port 13.

### Fourth Embodiment

Next, a fourth embodiment will be described by referring to the drawings.

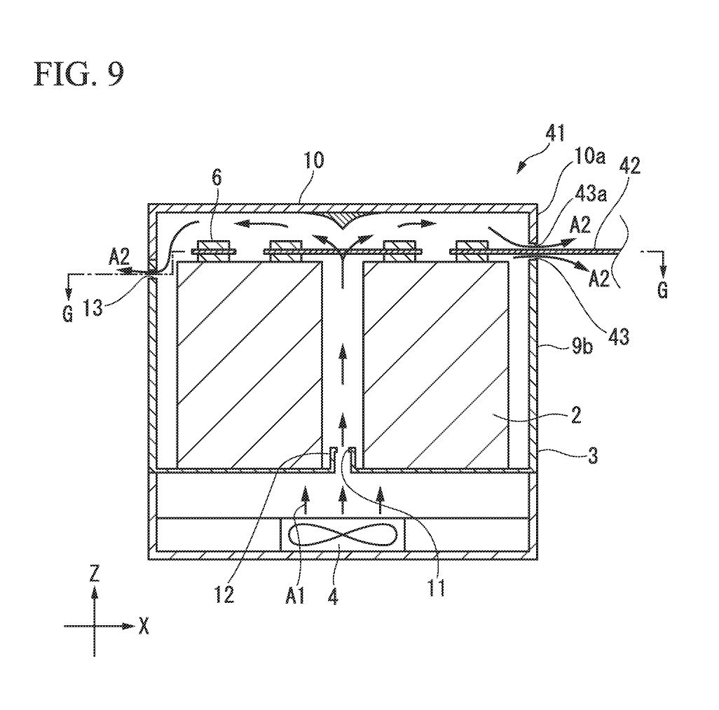

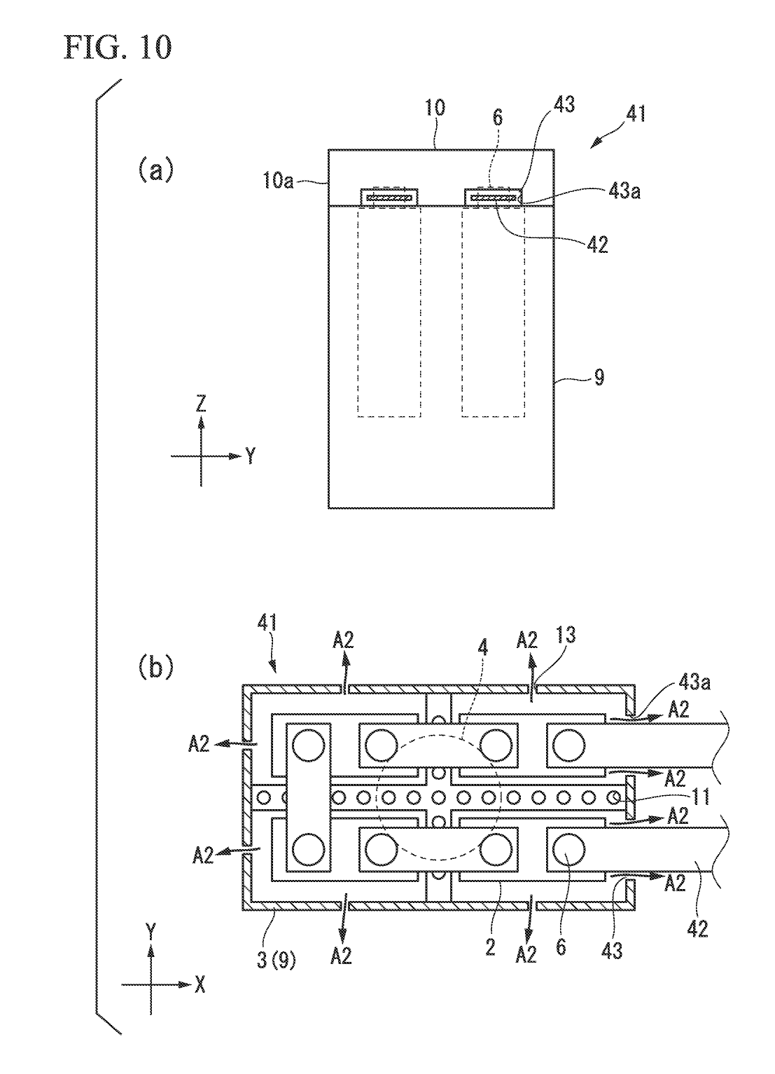

As illustrated in FIGS. 9 and 10, in a battery pack 41 according to the fourth embodiment, part of the electrode terminals 6 are connected to the electrode terminals 6 of the electrical cell 2 accommodated in the other battery pack 41 (not illustrated) by the busbar 42.

The embodiment is different from the first embodiment in that a busbar insertion hole 43 formed in the battery accommodation casing 3 also serves as the cooling fluid discharge port, and the other configurations are the same as those of the first embodiment.

That is, in the battery accommodation casing 3 illustrated in the embodiment, when the cover portion 10 and the accommodation portion 9 are combined with each other, the busbar insertion hole 43 is formed by the notched portion provided in the cover portion 10 near the lower portion of a side portion 10a (accommodation portion 9) and the upper end of the side portion 9b of the accommodation portion 9.

In the fourth embodiment, at least part of the cooling fluid discharge ports 13 corresponds to the busbar insertion hole 43. As illustrated in FIG. 10(a), the busbar insertion hole 43 is formed so as to be larger than the cross-sectional shape of the busbar 42, and a gap is formed between the inner peripheral surface 43a and the busbar 42.

Thus, as illustrated in FIG. 10(b), when the cooling fan 4 is driven so that the cooling air A1 is introduced into the battery accommodation casing 3, the air A2 inside the battery accommodation casing 3 is discharged from the cooling fluid discharge port 13 to the outside of the battery accommodation casing 3, and is also discharged from the busbar insertion hole 43 to the outside of the battery accommodation casing 3. In this way, in the side portion 9b of the accommodation portion 9 provided with the busbar insertion hole 43, the busbar insertion hole 43 also serves as the cooling fluid discharge port 13.

According to the battery pack 41 of the fourth embodiment, the cooling air A1 which is introduced from the cooling fluid introduction port 11 into the accommodation portion 9 is blown against the terminal surface 2a having the electrode terminal 6 and then is discharged from the cooling fluid discharge port 13 and the busbar insertion hole 43 to the outside of the battery accommodation casing 3, thereby obtaining the same effect as that of the first embodiment.

In addition to such the effect, in the embodiment, since the air A2 is discharged from the busbar insertion hole 43, it is possible to cool the busbar 42 inserted into the busbar insertion hole 43.

Furthermore, although the busbar insertion hole 43 is formed by the notched portion formed in the side portion 10a of the cover portion 10 and the upper end of the side portion 9b of the accommodation portion 9, the busbar insertion hole may be formed in the side portion 10a of the cover portion 10 or the side portion 9b of the accommodation portion 9 in accordance with the installation height of the busbar 42. Further, notched portions may be provided so as to correspond to both the lower portion side of the side portion 10a of the cover portion 10 and the upper portion side of the side portion 9b of the accommodation portion 9, and the open portions formed so as to match the notched portions may be used as the busbar insertion hole 43.

### Fifth Embodiment

Next, a fifth embodiment will be described by referring to the drawings.

The fifth embodiment to be described later is different from the first embodiment in that the electrode terminal insertion hole into which the electrode terminal 6 is inserted is formed in the cover portion 10, and the other configurations are the same as those of the first embodiment.

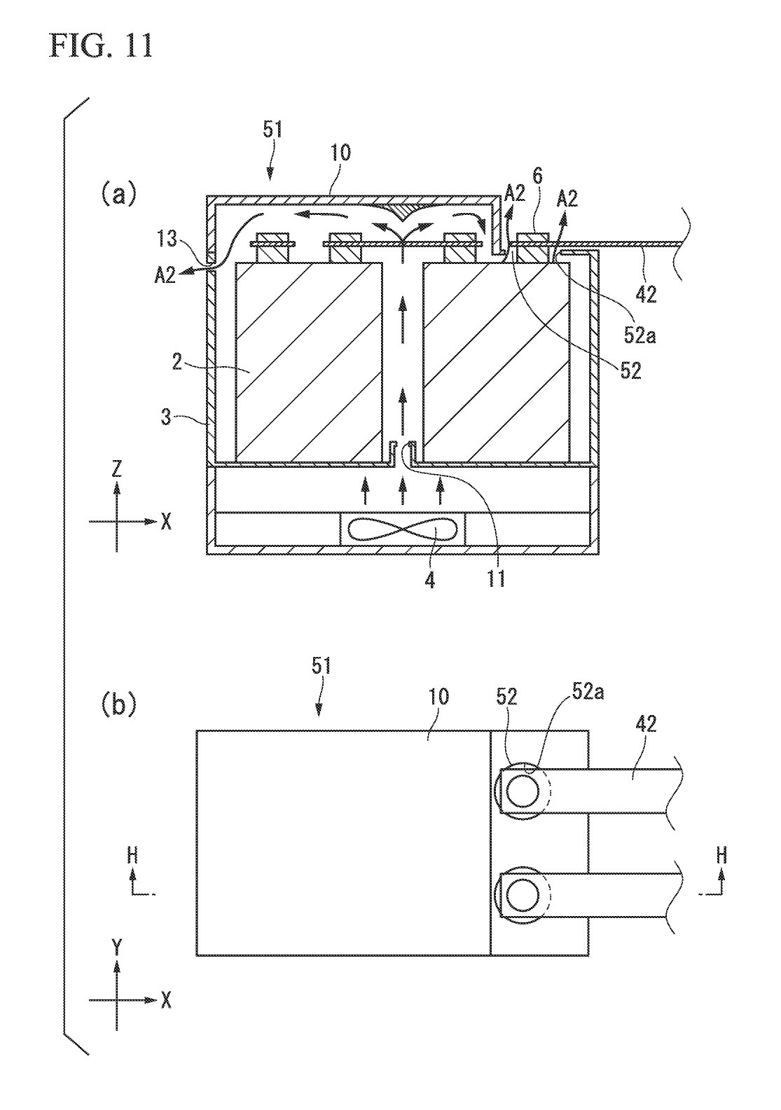

As illustrated in FIG. 11, in a battery pack 51 according to the fifth embodiment, parts of the electrode terminals 6 are connected to the electrode terminals accommodated in the other battery pack 51 (not illustrated) by the busbar 42. The electrode terminal 6 penetrates the cover portion 10 of the battery accommodation casing 3 so as to be exposed to the outside of the battery accommodation casing 3, and the busbar 42 is provided at the outside of the battery accommodation casing 3.

The cover portion 10 is provided with an electrode terminal insertion hole 52 into which the electrode terminal 6 is inserted. The electrode terminal insertion hole 52 is formed so as to be larger than the outer shape of the electrode terminal 6, and a gap is formed between the inner peripheral surface 52a and the electrode terminal 6.

In the fifth embodiment, when the cooling fan 4 is driven by the control unit 17 so that the cooling air A1 is introduced into the accommodation portion 9, the air A2 inside the battery accommodation casing 3 is discharged from the cooling fluid discharge port 13 to the outside of the battery accommodation casing 3, and is also discharged from the electrode terminal insertion hole 52 to the outside of the battery accommodation casing 3.

According to the battery pack 51 of the fifth embodiment, the cooling air A1 which is introduced from the cooling fluid introduction port 11 into the accommodation portion 9 passes by the terminal surface 2a having the electrode terminal 6 of the electrical cell 2 and is discharged from the cooling fluid discharge port 13 and the electrode terminal insertion hole 52 to the outside of the battery accommodation casing 3, thereby obtaining the same effect as that of the first embodiment.

While the respective embodiments of the battery system of the invention have been described, the invention is not limited to the above-described embodiments, and may be appropriately modified without departing from the spirit of the invention.

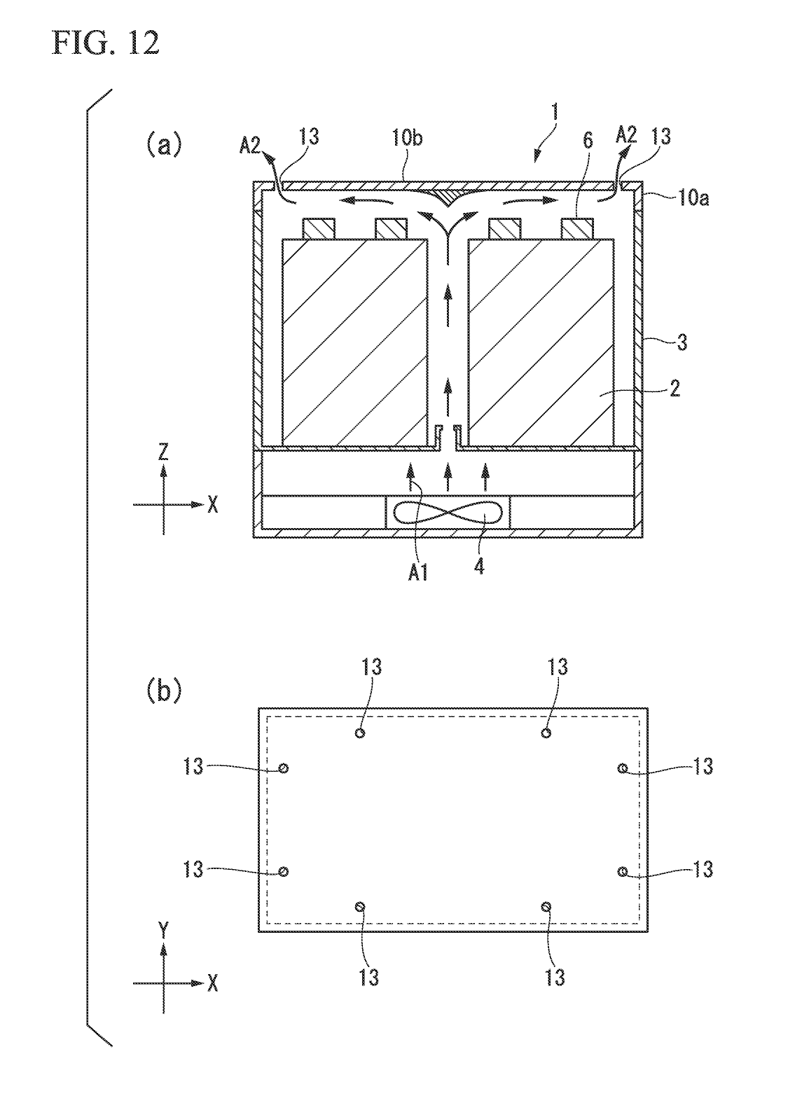

For example, in the above-described first embodiment, the cooling fluid discharge port 13 is provided in the side portion 9b of the accommodation portion 9, but may be provided in the side portion 10a of the cover portion 10 or the peripheral edge of the peripheral surface 10b instead of the side portion 9b of the accommodation portion 9 as illustrated in FIG. 12. In particular, when the cooling fluid discharge port 13 is provided in the peripheral surface 10b of the cover portion 10, the air A2 inside the accommodation portion 9 may be easily discharged to the outside of the battery accommodation casing 3 in a case where a plurality of the battery assemblies 20 are arranged so that no gap is formed between the adjacent battery assemblies 20 or the gap is narrow.

Further, in the above-described respective embodiments, each electrical cell 2 is provided with the thermistor 8; however, the thermistor 8 is not necessarily required. For example, the cooling fan 4 may be driven based on the other measurement values (the can potential, the terminal can voltage, or the like) instead of the thermistor 8 or the cooling fan 4 may be driven based on the command input through the input device 1d. Further, the cooling fan 4 may be normally driven without providing the thermistor 8 or the cooling fan 4 may be intermittently driven at a predetermined cycle.

In the above-described first embodiment, the cooling fan 4 is driven when the electrical cell 2 reaches a predetermined temperature or more, but the cooling fan 4 may be driven by the control unit 17 when any one of the other measurement information items becomes a predetermined numerical value or more or a predetermined numeral value or less (for example, when the absolute value of the current becomes a predetermined value or more).

In the above-described embodiments, the cooling fluid introduction port 11 is provided in the step portion 12, but the cooling fluid introduction port 11 may be provided in the surface flush with the surface where the electrical cell 2 is installed in the bottom portion 9a of the accommodation portion 9 without forming the step portion 12.

In the above-described embodiments, the cover portion 10 near the accommodation portion 9 is provided with the protrusion portions 14 and 32 of which the cross-sectional shapes are widened from the front end toward the cover portion 10, but the invention is not limited to this example. For example, instead of the protrusion portions 14 and 32, the surface of the cover portion 10 near the accommodation portion 9 may be formed in an uneven shape or a mesh-like member (metallic wool or the like) may be attached along the surface of the cover portion 10 near the accommodation portion 9. Even with such a configuration, the cooling air A1 which is introduced from the cooling fluid introduction port 11 into the accommodation portion 9 may be guided toward the terminal surface 2a having the electrode terminal of the electrical cell 2.

Further, in the above-described respective embodiments, the battery assembly is formed by two-dimensionally arranging the electrical cells 2. However, the battery assemblies disposed in two dimensions may be stacked and accommodated inside the battery accommodation casing 3 in three dimensions, the cooling air A1 may be made to blow from the lower side of the battery assemblies by the cooling fan 4.

### INDUSTRIAL APPLICABILITY

The present invention relates to a battery system including: a plurality of electrical cells in which electrode terminals are arranged side by side; a battery accommodation casing that includes an accommodation portion accommodating the plurality of electrical cells and a cover portion blocking an opening of the accommodation portion; and a cooling device that supplies a cooling fluid between the plurality of electrical cells accommodated in the accommodation portion from the opposite side to the surface provided with the electrode terminals, wherein the battery accommodation casing is provided with a cooling fluid introduction port that introduces the cooling fluid into the accommodation portion and a first cooling fluid discharge port that discharges the cooling fluid from the accommodation portion to the outside, and wherein the cover portion that faces the accommodation portion is provided with a cooling fluid guide portion that substantially evenly guides the cooling fluid toward the electrode terminals of the plurality of electrical cells. According to the present invention, it is possible to sufficiently cool the terminal surface having the electrode terminal of each electrical cell.

### REFERENCE SIGNS LIST

1: battery system
1a, 30, 31, 41, 51: battery pack
2: electrical cell
3: battery accommodation casing
4: cooling fan
6: electrode terminal
11: cooling fluid introduction port
13: cooling fluid discharge port (first cooling fluid discharge port)
14, 32: protrusion portion
22: cover portion side cooling fluid discharge port (second cooling fluid discharge port)
A1: cooling air
A2: air
d1: gap

1. A battery system comprising: a plurality of electrical cells in which electrode terminals are arranged side by side; a battery accommodation casing that comprises an accommodation portion accommodating the plurality of electrical cells and a cover portion blocking an opening of the accommodation portion; and a cooling device that supplies a cooling fluid between the plurality of electrical cells accommodated in the accommodation portion from the opposite side to the surface provided with the electrode terminals, wherein the battery accommodation casing is provided with a cooling fluid introduction port that introduces the cooling fluid into the accommodation portion and a first cooling fluid discharge port that discharges the cooling fluid from the accommodation portion to the outside, and wherein the cover portion that faces the accommodation portion is provided with a cooling fluid guide portion that substantially evenly guides the cooling fluid toward the electrode terminals of the plurality of electrical cells.

2. The battery system according to claim 1, wherein the cooling fluid guide portion is a protrusion portion that protrudes from the cover portion toward the electrode terminals of the electrical cells.

3. The battery system according to claim 2, wherein the protrusion portion is provided at a position facing the cooling fluid introduction port in the cover portion, and the radial cross-section is formed in a shape that is widened from a front end forming the protrusion portion toward the cover portion.

4. The battery system according to claim 3, wherein a plurality of the protrusion portions are formed in a substantially circular shape so as to be concentric with each other, and wherein the centers of the respective protrusion portions substantially match the centers of the plurality of arranged electrical cells in the plan view from the height direction of the electrical cell.

5. The battery system according to claim 4, wherein a plurality of the cooling fans are provided, and wherein a region surrounded by the plurality of cooling fans in the cover portion in the plan view from the height direction of the electrical cell is provided with a second cooling fluid discharge port that discharges the cooling fluid to the outside of the battery accommodation casing.

6. The battery system according to claim 1, further comprising: a high-order control device that acquires information on the driving state of the cooling device; and a display unit that displays the information on the driving state.

7. The battery system according to claim 2, further comprising: a high-order control device that acquires information on the driving state of the cooling device; and a display unit that displays the information on the driving state.

8. The battery system according to claim 3, further comprising: a high-order control device that acquires information on the driving state of the cooling device; and a display unit that displays the information on the driving state.

9. The battery system according to claim 4, further comprising: a high-order control device that acquires information on the driving state of the cooling device; and a display unit that displays the information on the driving state.

10. The battery system according to claim 5, further comprising: a high-order control device that acquires information on the driving state of the cooling device; and a display unit that displays the information on the driving state.
